(19) United States
(12) Patent Application Publication
(10) Pub. No.: US 2005/0224467 A1
(43) Pub. Date: Oct. 13, 2005

(54) Method and welding device for contour welding

(75) Inventors: Andre Val, ANDELFINGEN (CH); Jakob Muller, Enges (CH)

Correspondence Address: McCormick Paulding & Huber, 185 Asylum Street, City Place II, Hartford, CT, 06103-4102, US

(73) Assignee: ELPATRONIC AG, BERGDIETIKON (CH)

(21) Appl. No.: 10/507,651

(22) PCT Filed: Mar. 12, 2003
(86) PCT No.: PCT/CH03/00165

§ 371 Date: May 12, 2005

(30) Foreign Application Priority Data
Mar. 12, 2002 (CH) 428/02

(51) Int. Cl. B23K 11/06

(52) U.S. Cl. 219/83

(57) ABSTRACT

On a contour welding machine with welding rollers), the workpiece is arranged on a holder that is freely rotatable during the welding operation. Its rotation by the driven welding rollers engaging the workpiece is compensated to a greater or lesser degree to suit the contour profile by shifting the position of the holder in relation to the welding rollers. This enables contours to be welded simply and inexpensively. With a driven check angle, a skip back to the starting point can be made in the case of open contours and/or friction rollers can be dispensed with.

### TECHNICAL FIELD

The invention relates to a method for contour welding and/or contour tracking according to the introductory part of claim 1. The invention also relates to a welding apparatus for contour welding and/or a contour tracking apparatus according to the introductory part of claim 11. The invention also relates to a method and an apparatus according to claims 19 and 21 respectively.

Containers such as fuel tanks which comprise two half-shells with a common flange are usually made by contour welding. The flange is welded between the welding rollers. Flat sheet-metal blanks intended for subsequent hydroforming are also welded along a desired contour with one blank laid over the other.

### STATE OF THE ART

The use of roller seam welding machines as contour welding machines is known. Two welding rollers—upper and lower—with a wire electrode fed to each, follow the contour of the overlaid welding flanges of the container halves, which have first been tacked together. To weld containers, it is known to provide a workpiece table to seat the tacked container, this table being provided with a contour, e.g. an outer contour, corresponding to the tank contour to be welded. The workpiece table is then moved along its contour, thereby also moving the welding flange of the container, which is fixed to the table, between the welding rollers mounted in a fixed position on the machine. This technique of moving the container, with the table driven in a known manner by means of toothing on the outer contour of the table and a drive pinion meshing thereon, and also with a driven arm (called a pantograph) engaging the table to keep the contour tangential to the welding direction, has proved effective for the welding of containers with level welding flanges, and can also be used in accordance with EP-A-0622147 for welding flanges with three-dimensional profiles. Because the traced contour is mechanically preordained by the outer contour of the table, this solution is not flexible where changes of contour need to be made or where different contours need to be welded, e.g. for short production runs. Moving the container by means of a robot has also been proposed, e.g. in accordance with U.S. Pat. No. 5,010,226 or DE-A-3603919. However, robots are expensive and need laborious programming, and create problems of space and/or working safety.

### STATEMENT OF THE INVENTION

Accordingly the fundamental object of the invention has been to provide a method and/or an apparatus offering a simple possibility of contour welding by means of roller seam welding machines—and/or of tracking a contour on some other processing machine—that does not have the said drawbacks. This object is realized by the characterizing features of claims 1 and 11 respectively.

As the workpiece is now freely rotatable on its holder, the contour does not need to be determined mechanically, but results from the rotation of the workpiece brought about by the driven welding rollers, which is offset to a greater or lesser degree by shifting the position of the rotational axis. This shift can be effected by a simple kinematic arrangement. By controlling the welding rollers and the shift, contours can be traced in a simple and inexpensive fashion. Changes of contour can be obtained simply by modifying the motion-programming of the control. The contour may have convex and/or concave curve forms; the minimum radii are set by the mechanical geometry of the machine.

Preferably, the rotational angle of the freely rotatable workpiece, or the rotational angle of its holder, is detected. This allows closed-loop feed control whereby the tracing of the contour can be corrected in real time.

The method and apparatus are primarily claimed, and herein described, in the context of their chief area of application, namely contour welding. In principle, the basic principle described can also be used to track a contour for other applications. Again the essential features are the freely rotatable holder and the provision of driven rollers—which in this case will not be welding rollers—which grip the workpiece and whose rotation of the workpiece about the rotational axis is completely or partially offset, or over-compensated, by changing the position of the rotational axis. Tools are then located beside the rollers, such as a marker which draws the contour on the workpiece, or e.g. a laser cutting head which cuts the workpiece in accordance with the contour.

Another solution is claimed in claims 19 and 21 respectively.

### BRIEF DESCRIPTION OF THE DRAWINGS

Embodiments will now be described in detail with the aid of the drawings, in which

FIG. 1 shows schematically a roller seam welding machine according to the invention, in side view;

FIGS. 2 to 7 show simplified views from above of the machine of FIG. 1 in various positions in the course of tracing a contour, and

FIG. 8 shows an embodiment without welding or clamping rollers, with driven rotation about the vertical axis; and

FIGS. 9 to 14 show motions obtained with the embodiment according to FIG. 8.

### BEST WAY OF CARRYING OUT THE INVENTION

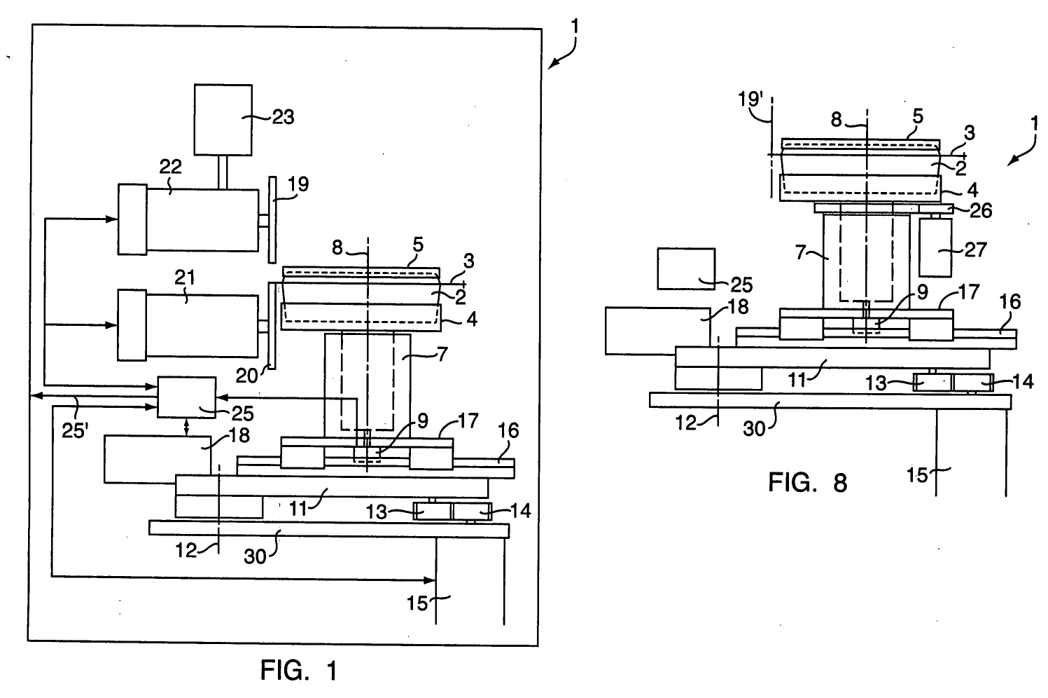

FIG. 1 shows in schematic side view a roller seam welding machine or contour welding machine which is configured in accordance with the invention and/or on which the method according to the invention can be carried out. The welding machine 1 has a machine frame 30, which is only adumbrated, and on which the further components stated below are mounted. These comprise in particular a seat 4 or table 4 to receive the workpiece 2, 3, and preferably also an upper holder 5 and/or suction units or electromagnets in the holder arrangement fixing the workpiece on the table 4. The shape of the table 4 may be adapted to the workpiece 2, so facilitating positioning of the workpiece on the table. In the illustrated example, the workpiece 2 is a container formed from two halves which together form a flange 3 which must be welded along a specified contour. But as stated above, the workpiece may also consist of two substantially flat sheet-metal blanks which are welded one on top of the other. Welding is performed in a manner known in itself by means of welding rollers 19 and 20 over which an intermediate wire electrode runs. This electrode is not shown in the drawing, but is known and does not need to be described in detail here. The welding rollers 19 and 20 possess a current supply and, if need be, a cooling system, and are in this case driven, as is generally shown in the drawing by the upper and lower welding roller drives 22 and 21 respectively. An actuating element 23 lowers the upper welding roller 19 for welding so that it bears on the flange 3 of the workpiece 2 with the requisite pressure. For loading of the machine with the tacked container halves, and for removal of the welded container, the roller is moved into the raised position shown.

According to the invention, the seat 4 with the holder 5, and hence the workpiece 2, are carried by a rotary support 7 arranged underneath the seat 4, and so are freely rotatable about an axis 8. Here “freely rotatable” signifies that the workpiece seat 4 and the workpiece 2 can be freely rotated about the axis 8 when forces are applied to them. The axis 8 is perpendicular to the welding plane, which essentially coincides with the plane of the flange 3. For loading, the work seat or table 4 can preferably be locked in a defined starting position prior to welding so that loading can always be performed with the table 4 in the same starting position, which is advantageous for automatic loading. The starting position simultaneously forms a defined initial position for the tracing of the contour. Since the whole of the contour has been traced when welding is complete, the workpiece seat 4 is then once again in the position corresponding to the starting position. On completion of welding, therefore, the table is normally locked by means which are not shown so that it is fixed in this position which also serves as a starting position. Then, after removal of the welded workpiece, it can be loaded with another workpiece to be welded, whereupon the welding rollers 19 and 20 are brought into the welding position, and the lock on the table 4 is released so that it is freely rotatable about the axis 8 during welding. The rotary support 7 and hence the axis 8 are shiftably arranged on the machine 1 so that the position of the axis 8 can be varied during welding. This variation can be mechanically realized in any suitable way. For instance, the rotary support 7 could be arranged on an X-Y table which executes the driven displacement in X and Y directions while the axis 8 constitutes the Z direction. In this case the shift drive preferably forms part of the welding machine 1. However, matters could be arranged so that only the shiftable mounting of the rotary support 7 is arranged on the welding machine and its drive is external, e.g. a robot or a loading arrangement which has first placed the workpiece on the rotary support and work seat 4. It would also be feasible to vary the position of the rotary support entirely by an external robot, without guiding the rotary support on the welding machine. This could be done by feeding a signal from the control unit 25 of the machine 1 to the robot, as will be explained presently. Preferably, however, the mechanism for varying the position of the rotary support 7 is part of the welding machine 1, as the benefits of the present invention are then realized to best advantage. In the case of the illustrated embodiment, the rotary support 7 is arranged on a linear guide which has rails 16 and a carriage 17 travelling thereon which, in turn, carries the rotary support 7. The carriage 17 is linearly displaceable along the guide 16 by a drive 18, e.g. a spindle drive with an electric motor. The guide 16 with the carriage 17 is itself arranged on a swivel plate 11 which can be swivelled about a swivel axis 12, for which purpose a segment gear 13 may be arranged underneath the plate 11. A pinion 14 driven by an electric motor 15 meshes with this segment gear 13. The plate 11 can thus be driven through a specified angle in a swivelling motion about the swivel axis 12, as will later be explained. The swivel axis 12 is parallel with the rotational axis 8.

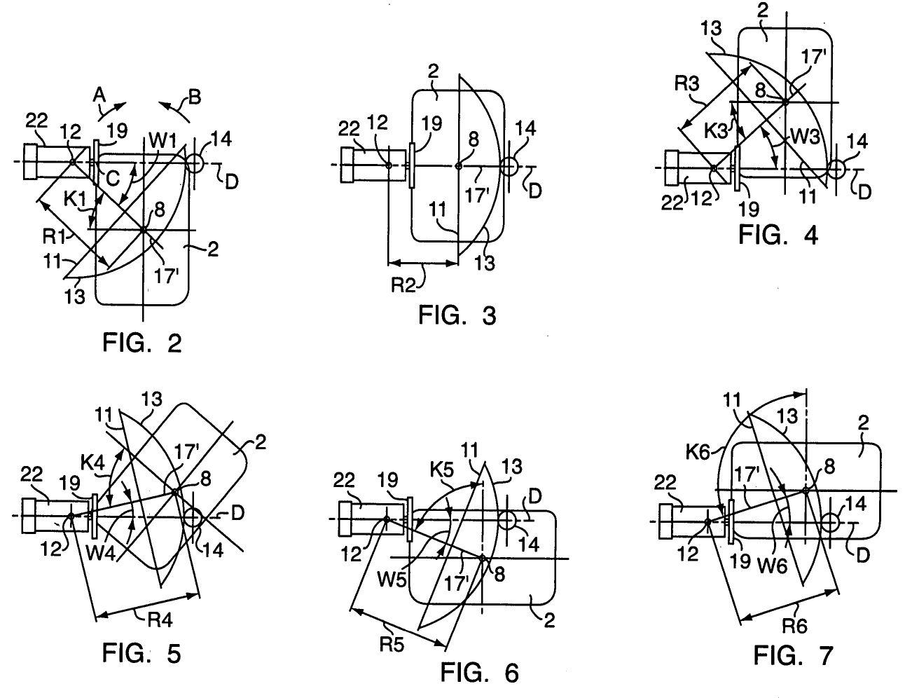

Also provided is an angle transmitter 9 which delivers a signal governed by the angle of rotation of the freely rotatable work seat 4 or workpiece 2. This signal is delivered to the control 25 which in turn is linked to the said drives 15, 18, 21 and 22 and is also able to control other elements of the machine such as in particular the lowerable holder 5 for the workpiece. As has already been mentioned, external signals can also be given by the control unit, as suggested by the link 25′. The method will now be described in detail with the aid of FIGS. 2 to 7 showing a simplified top view of the welding machine of FIG. 1 with various workpiece positions. FIG. 2 reveals in particular the upper welding roller with its drive 22. The workpiece 2 is also seen, from above; as is, schematically, the plate 11, which can swivel about the swivel axis 12, and in order to simplify the drawing is shown simply as a line; and also the segment gear 13, with which the driven pinion 14 of the swivelling drive, which is fixed to the machine, meshes. The linear guide 16, 17 which carries the rotary support 7 and with it the swivel [sic] axis 8 is indicated simply by the line 17′ in order to avoid cluttering the drawing. Repositioning by the linear drive changes the distance of the rotary support 7 (which is not shown in FIGS. 2 to 7) and rotational axis 8 (which is) from the swivel axis 12, as is shown in the figure by the distance R1 (radius 1). The corresponding radii in the other figures are similarly designated R2 to R6. K1 (check angle 1) is the angle detected by the rotational angle transmitter 9. The corresponding angles in the other figures are designated K3 to K6. W1 and W3 to W6 denote the swivel angle of the plate 11 and of 17′, so that W and R are the polar co-ordinates of the position of the axis 8. FIG. 2 shows a possible starting position in which the workpiece 2 has been loaded into the locked work seat and fixed therein. The upper welding roller is now lowered on to the workpiece 2, or its flange 3, and welding can begin at the starting point C once the lock on the workpiece seat 4, or workpiece 2, has been released. The welding rollers 19 and 20 are now driven in rotation and supplied with welding current in order to weld the contour. The actual welding can be carried out with conventional parameters. Coated [or] uncoated steel or other weldable sheet or plate can be welded at a fixed speed of travel or at a speed of travel adapted to the contour, with a conventional, preferably elliptical, wire electrode. Other wire shapes (flat, longitudinally grooved, trielliptic and other), or welding rollers without wire, may also be considered. The weld width may be e.g. 1.2 mm, and the welding force e.g. 90 daN with a welding current of e.g. 6.5 kA. The weld width, welding force and welding current are highly dependent on the material to be welded, the coating, the thickness of the sheet or plate and the speed of travel.

With driven rotation of the welding rollers 19, 20, which tightly grip the flange 3 between them and are fixed with respect to the machine, there will be a rotation moment tending to turn the workpiece 2 about the axis 8. If welding is being performed along the long side of the workpiece in FIG. 2, the direction of rotation will be as indicated by the arrow A. On the other hand, a rotation of the workpiece in the direction indicated by the arrow B can be brought about by a shift in position of the rotational axis 8 about the point at which the workpiece 2 is clamped between the welding rollers 19, 20, if the rotational axis 8 in FIG. 2 is moved in the direction of the line D, causing the angle W1 to diminish. By balancing the rate of rotation of the welding rollers 19 and the shift of the rotational axis 8, the two rotations of the workpiece 2 about the axis 8 can be offset so that the workpiece is moved between the welding rollers in a straight line. Starting from the position of FIG. 2, this is accordingly accomplished by driving the pinion 14 clockwise, producing a swivelling motion of the rotational axis 8 about the swivel axis 12 towards the line D, while at the same time the radius R1 is changed so that the workpiece is moved between the welding rollers 19, 20 on the straight-line contour to be welded. FIG. 3 shows the corresponding position halfway along the long side of the workpiece to be welded between the welding rollers 19, 20. The angle marked in FIG. 2 as angle W1 is now 0°, and the rotational axis 8 is located on the line D. The distance of the rotational axis 8 from the swivel axis 12 is at a minimum and is equal to R2. As the welding rollers 19, 20, and the workpiece 2, continue to be driven, swivelling of the swivel guide about the swivel axis 12 continues, as illustrated in FIG. 2 in the end position of the welding of the long side of the workpiece 2. Compared with FIG. 2, the rotational axis 8 has now swivelled to its furthest remove on the other side of the line D. The first curve in the contour must now be welded. The welding rollers continue driving the workpiece; in the curved section of the contour, the speed of the welding rollers may be reduced. Meanwhile the welding rollers continue to bring about a rotation of the workpiece in the direction of the arrow A about the rotational axis 8 which is now exploited in order to trace a curved contour, while the shifting of the position of the swivel [sic] axis 8 no longer fully offsets the rotation of the workpiece in the direction A as has hitherto been the case. The pinion 18 is now driven anticlockwise but at reduced speed, so that the rotation of the workpiece in the direction A imparted by the welding rollers is greater than that caused by the swivel guide in the direction B, with the result that the workpiece 2 now executes a rotational movement as shown in FIG. 5. By a judicious choice of the speed of the welding rollers and of the magnitude of the compensation movement due to a shift of the rotational axis 8, contours of any desired profile can be obtained. FIG. 5 shows a position in which the workpiece is continuing to turn about the rotational axis 8, as the welding rollers are imparting a rotation in the direction A that is greater than the rotation of the workpiece in the direction B about its clamping point between the welding rollers induced by the shift in position of the rotational axis 8.

FIG. 6 shows the position at the end of the curved part of the contour. Once again a straight part of the contour now has to be welded. Therefore, the pinion 14 is again driven at a speed at which the rotational movements of the workpiece in the direction of rotation A and in the direction of rotation B exactly cancel out, so that welding is performed in a straight line.

After this straight contour has duly been welded, another radius of the contour is welded, with the rotation of the workpiece in the direction A induced by the welding rollers exceeding the rotation of the workpiece in the direction B due to the shift in position. The whole contour of the workpiece can easily be traced in this way, until once again the point C of FIG. 1 is reached, whereupon the welding current is switched off, the workpiece seat is locked and the upper welding roller is raised. The workpiece can now be unloaded and a new workpiece inserted into the welding machine, whereupon the cycle is repeated.

As has been made clear, the freely rotatable holder of the workpiece and the shifting of the rotational axis 8 allow any desired contour (convex and/or concave) to be traced by causing the rotation of the workpiece in the direction A, induced by the welding rollers, to be more or less offset, or over-compensated, by the shift in position of the rotational axis accompanied by rotation in the direction B. With a full offset, a straight contour is traced; with a partial offset, a more or less curved contour, as shown in the example. With over-compensation, an outwards-curving contour results, unlike the contour shown in the example. The rate of rotation (speed of travel) of the welding rollers is set by the control 25, which also determines the shift of the rotational axis 8 by acting on the drives 15 and 18. Tracing of the contour may be performed with open-loop control i.e. with the control adhering to contour-related preset values for welding roller speed and for the position of the rotational axis 8. Preferably, however, the process is carried out with closed-loop feedback control by means of the angle transmitter 9, which detects the check angle K and feeds it to the control 25. The check angle K is determined for every contour point on the contour. During welding of the contour, the check angle covers 360°. Thus a check angle value can be assigned to every point on the contour. This is done when the control is programmed with the contour co-ordinates. In this case, the actual check angle measured by the rotational angle transmitter 9 at each point on the contour can be compared by the control with the check angle previously computed and stored in memory. The deviation of the measured check angle from the required check angle value, which corresponds to a deviation from the required contour, can be offset by the control either by modifying the speed of the welding roller drive or by influencing the drive to the swivel guide accordingly. It would also be possible to act on both drives simultaneously. Assuming that modifying the speed of the welding rollers is the preferred option, then, if the check angle for a given contour position proves too small, the welding roller drive is modified so that the speed of the welding rollers is increased; if on the other hand the check angle is too large, the speed of the welding rollers is reduced. Variations in speed caused by the contour or any necessary correction may also affect the welding current.

If the shift of the rotational axis 8 is produced by an external drive which is not part of the welding machine 1, and which may be e.g. a robot, the control 25 may deliver an external control signal via a line 25′ so that the robot control can be supplied with the necessary correction signal.

In the example shown, welding of a two-dimensional contour has been described.

However, it is also possible to weld a three-dimensional contour profile in which the contour also ranges in the Z axis. The two-dimensional set-up is supplemented by a shifting of the rollers in the Z axis and a deflection—matched to the slope—about a horizontal axis through the welding point parallel with the roller axes. The control 25, according to the stored contour profile, then prompts the vertical shift and the deflection of the welding rollers to suit the desired contour profile. The shift in contour in the Z axis is projected on to the X/Y axis and traced in like manner. The height difference on the Z axis yields the slope. From this, the deflection of the rollers is calculated and set.

The tracing of the contour has here been described in the context of the preferred application i.e. welding. However, it is possible to trace a contour by the method according to the invention where no welding is involved, the welding rollers 19 and 20 then being replaced simply by currentless, driven clamping rollers that trace the contour without making a weld. In this case, a different processing and/or marking tool is provided beside the clamping rollers, such as a laser, which operates on the workpiece, which in this case may be e.g. a single sheet or plate which is cut by the laser.

In another solution, a contour is traced without welding rollers or friction rollers. In this case the check angle of the axis 8 is altered by an additional controlled drive 26, 27 (FIG. 8 ff.) for the work seat 4. This solution enables a contoured edge to be cut by means of a laser, flame-cutting torch, water jet, or other means, as suggested by the processing point 19′; though if the check angle is actively driven, automatic monitoring and correction of the contour are sacrificed. With an active drive 27 of the rotational axis 8, contours that are open, rather than closed, can also be produced; or on completion of the contour a skip can be made to a specific new position, e.g. a loading or unloading position.

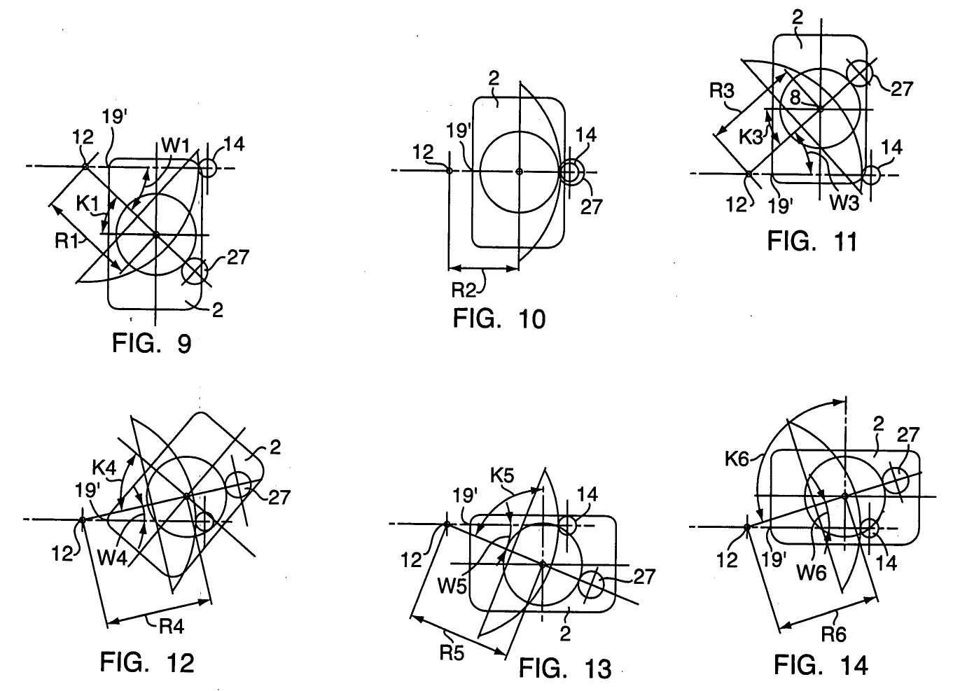

In this aspect of the invention, then, the turning moment about the axis 8 is not produced by welding rollers or clamping rollers. A controlled drive 26, 27, e.g. an electric motor, rotates the workpiece seat 4 about the axis 8, under- or over-compensated by the drive 27, to trace the contour, which is preferably processed or inspected on the workpiece by any desired processing means, e.g. a laser beam, or inspection means. Other remarks made on the example of FIGS. 1 to 7 still apply to this further aspect of the invention, and the elements in FIGS. 8 to 14 are designated by the same reference symbols as in FIGS. 1 to 7. FIGS. 9 to 14 likewise show various positions during the tracking of a contour, the rotation of the workpiece seat about the axis 8 now being induced by the drive 27.

1. A method for contour welding by means of welding rollers, characterized in that the workpiece to be welded is held freely rotatably about a rotational axis perpendicular to the welding plane so that the welding rollers driven for welding induce a rotation of the workpiece about the rotational axis, and in that the rotational axis is shifted during welding so that the rotation of the workpiece induced by the welding rollers is offset in straight contour sections and is partially offset or over-compensated, in curved contour sections.

2. Method according to claim 1, characterized in that the rotational axis is shifted by driven shifting means belonging to the welding machine or by extraneous shifting means.

3. Method according to claim 2, characterized in that the shifting means belonging to the welding machine comprise a first guide means pivotable about a swivel axis for the rotational axis, and a second, linearly shiftable guide means for the rotational axis.

4. Method according to claim 1, characterized in that the shifting of the rotational axis and the drive to the welding rollers are controlled by a common control.

5. Method according to claim 4, characterized in that the control operates as a closed-loop feedback control by processing as input quantity the rotational angle (K) of the workpiece about the rotational axis.

6. Method according to claim 5, characterized in that the closed-loop feedback control determines by its output quantity the speed of the welding roller drive, the speed being increased when the rotational angle is too small and reduced when the rotational angle is too large.

7. Method according to claim 6, characterized in that corresponding rotational angle data are assigned to the stored contour data in the control.

8. Method according to claim 1, characterized in that three-dimensional contours are welded by an additional vertical shifting of the rotatable holder or of the welding rollers and deflection of the same about a horizontal axis through the welding point parallel with the roller axes.

9. Method according to claim 1, characterized in that clamping rollers are used in order to simply trace a contour instead of welding, a tool or inspection means being arranged beside the clamping rollers.

10. Method according to claim 9, characterized in that the tool is a marking and/or processing tool.

11. A welding apparatus for contour welding with driven welding rollers, characterized in that the apparatus has a holder to seat the workpiece to be welded that during the welding operation is freely rotatable about a rotational axis and additionally adjustable in position with respect to the welding rollers by variation of the position of the rotational axis, and in that a control and drive means are provided by means of which the speed of the welding rollers and the positioning of the holder can be varied during the welding operation.

12. Welding apparatus according to claim 11, characterized in that a sensing device for the rotational angle of the holder is provided whose output signal is connected to the control.

13. Welding apparatus according to claim 12, characterized in that the control is configured as a closed-loop feedback control which generates a speed signal for the drive to the welding rollers from the output signal of the sensing device.

14. Welding apparatus according to claim 10, characterized in that the position of the rotational axis can be varied by the control by means of a swivel guide driven about a swivel axis and a driven linear guide arranged thereon.

15. Welding apparatus according to claim 11, characterized in that the holder or the welding rollers are vertically adjustable and deflectable about an axis passing through the welding point for the welding of three-dimensional contours.

16. Welding apparatus according to claim 12, characterized in that the signal from the sensing device is passed directly or via the control to an output connection.

17. Contour tracking apparatus according to claim 11 wherein the welding rollers are replaced by clamping rollers with no welding function.

18. Contour tracking apparatus according to claim 17, characterized in that a marking and/or processing tool, is arranged beside the clamping rollers.

19. Method for contour tracking, characterized in that a part to be processed or inspected along a contour is held drivably in rotation about a rotational axis perpendicular to the processing or inspection plane by a drive separate from the processing or inspection means so that the drive is able to induce a rotation of the part about the rotational axis, and that the rotational axis is shifted during the processing or inspection so that the drive-induced rotation of the part is at least partially offset or over-compensated.

20. Method according to claim 19, characterized in that the rotational axis is shifted by driven shifting means belonging to the welding machine or by extraneous shifting means.

21. Contour tracking apparatus characterized in that it has a holder to seat a part to be processed or inspected that during the operation is rotatable about a rotational axis by drive means acting on the work seat and additionally adjustable by variation of the position of the rotational axis by a second drive means, and in that a control is provided for the first and second drive means.

22. Contour tracking apparatus according to claim 21, characterized in that a sensing device for the rotational angle of the holder is provided whose output signal is connected to the control.

23. A method for contour welding by means of welding rollers, comprising the steps of:
holding a workpiece to be welded in a manner where it is freely rotatably about a rotational axis that is perpendicular to a welding plane, wherein the welding rollers are operable to induce a rotation of the workpiece about the rotational axis; and
shifting the rotational axis during welding so that rotation of the workpiece induced by the welding rollers is offset in straight contour sections and is at least partially offset or over-compensated in curved contour sections.

24. A welding apparatus for contour welding with driven welding rollers, comprising:
a holder for seating a workpiece to be welded, wherein the holder is rotatable about a rotational axis and adjustable in position with respect to the welding rollers by variation of the position of the rotational axis;
a control and drive means operable to vary the speed of the welding rollers and the position of the holder during a welding operation.

25. A method for contour tracking, comprising the steps of:
holding a workpiece to be tracked in a manner such that the workpiece is held rotatable about a rotational axis perpendicular to a plane so that clamping rollers induce a rotation of the workpiece about the rotational axis;
providing one or both of a tool or inspection means arranged beside the clamping rollers; and
shifting the rotational axis during the contour tracking so that the rotation of the workpiece induced by the clamping rollers is offset in straight contour sections and is at least partially offset or over-compensated, in curved contour sections.
